(19) United States
(12) Patent Application Publication
(10) Pub. No.: US 2009/0160967 A1
(43) Pub. Date: Jun. 25, 2009

(54) Determination of shooting scene and image processing for the determined scene

(75) Inventor: Toshie Imai, Nagano-ken (JP)

Correspondence Address: MARTINE PENILLA & GENCARELLA, LLP, 710 LAKEWAY DRIVE, SUITE 200, SUNNYVALE, CA, 94085, US

(73) Assignee: Seiko Epson Corporation

(21) Appl. No.: 12/378,389

(22) Filed: Feb. 13, 2009

Related U.S. Application Data
(63) Continuation of application No. 10/912,514, filed on Aug. 4, 2004.

(30) Foreign Application Priority Data
Aug. 8, 2003 (JP) 2003-289696

(51) Int. Cl. H04N 5/228; G06K 9/46

(52) U.S. Cl. 348/222.1; 382/195; 348/E05.024

(57) ABSTRACT

A CPU 30 generates reduced image data for analytical use from the input image data, analyzes the generated analytical reduced image data on a pixel-by-pixel basis, and acquires R, G, B components of each pixel that constitutes the analytical reduced image data. By using the result of analysis of the analytical reduced image data, the CPU 30 decides a characteristic hue or a hue that characterizes the image data, decides a pixel area that corresponds to the decided characteristic hue, executes a frequency analysis of the analytical reduced image data through the use of e.g. a two-dimensional Fourier transformation, and extracts a texture of the pixel area that corresponds to the characteristic hue. The CPU 30 decides a shooting scene of the shooting image (image data) based on the acquired characteristic hue and the texture of the pixel area that represents the characteristic hue.

### CROSS-REFERENCE TO RELATED APPLICATIONS

This application is a continuation of U.S. patent application Ser. No. 10/912,514, filed on Aug. 4, 2004, the disclosure of which is hereby incorporated by reference in its entirety.

### BACKGROUND OF THE INVENTION

1. Field of Technology

The present invention relates to an image processing device that executes image processing according to types of shooting scenes.

2. Description of the Related Art

A variety of image processing techniques for image data are in research and in practical use along with the popularization of digital still cameras (DSCs). An example of a well-known technique associates information on a shooting image (shooting scene) at the time of shooting i.e. on-shoot information with image data and uses the on-shoot information to execute appropriate image processing of the image data according to the shooting scene.

Another well-known technique causes a user to designate a shooting scene at the time of image processing and thereby enables appropriate image processing of the image data according to the shooting scene.

Further well-known technique analyzes the image data without using information on a shooting scene and executes image processing of the image data based on the result of analysis such as statistics.

Among the conventional image processing techniques, the technique that causes a user to designate a shooting image must deal with the complexity of designating a shooting image for every piece of image data if a large quantity of data is to be processed at a time.

In the technique that uses on-shoot information, if a wrong shooting scene is set up by a user, the image processing may possibly be executed inappropriately on an actual shooting scene. There is also some difficulty in setting up an appropriate shooting scene for a compositive shooting scene. This may result in a high possibility that no appropriate shooting scene is set for an actual shooting scene.

In the conventional technique that uses the result of analysis on the image data, no shooting scene is determined for the image processing. The image processing executed thereby thus does not reflect the type of shooting image.

### SUMMARY OF THE INVENTION

The purpose of the present invention is to solve the above-mentioned problems and to determine a shooting scene by analyzing image data. Another purpose of the present invention is to execute appropriate image processing of the image data according to its characteristic or the shooting scene that is obtained by the analysis on the image data.

In order to solve the above-mentioned problems, a first aspect of the present invention provides an image processing method. The image processing method of the first aspect of the present invention comprises acquiring image data; deciding a characteristic hue that characterizes the acquired image data by analyzing the image data; and executing an image quality adjustment of the image data according to the decided characteristic hue.

According to the image processing method of the first aspect of the present invention, a characteristic hue that characterizes the image data is decided by the analysis of the image data, and an image quality adjustment is executed according to the decided characteristic hue. This allows for execution of appropriate image processing of the image data with no disturbance of its characteristic hue.

The image processing method of the first aspect of the present invention may further comprises specifying an area that corresponds to the decided characteristic hue from among the acquired image data; extracting a texture for the image data that corresponds to the specified area; and executing an image adjustment of the image data according to the decided characteristic hue and the extracted texture. In such a case, a texture is extracted and thus a pattern can be determined for an area that corresponds to the characteristic hue, which allows for execution of more appropriate image processing of the image data.

In the image processing method of the first aspect of the present invention, the image data may be associated with at least one of on-shoot information and image processing control information, and the image quality adjustment of the image data may be executed by applying the on-shoot information. The on-shoot information is a piece of information that relates to a shooting scene at the time of shooting; whereas the image processing control information is a piece of information that designates an image processing condition for the image data. In such a case, the use of at least one of the on-shoot information that is responsive to the shooting scene and the image processing control information that designates the image processing condition for the image data in combination with the characteristic hue and the texture allows for execution of image processing of the image data in a way responsive to the shooting scene.

A second aspect of the present invention provides an image processing method. The image processing method of the second aspect of the present invention comprises acquiring image data; deciding a characteristic hue that characterizes the acquired image data by analyzing the image data; and determining a shooting scene by using the decided characteristic hue.

According to the image processing method of the second aspect of the present invention, a characteristic hue that characterizes the image data is decided by the analysis of the acquired image data, and a shooting scene is determined by the use of the decided characteristic hue. In other words, the analysis of the image data can result in the determination of the shooting scene.

The image processing method of the second aspect of the present invention may further comprise specifying an area that corresponds to the decided characteristic hue from among the acquired image data; extracting a texture for the image data that corresponds to the specified area; and determining a shooting scene by using the extracted texture in addition to the decided characteristic hue. In such a case, a texture is extracted and thus a pattern can be determined for area that corresponds to the characteristic hue, which allows for more appropriate determination of the shooting scene.

In the image processing method of the second aspect of the present invention, the image data may be associated with at least one of on-shoot information and image processing control information, and the shooting scene may be determined by applying the on-shoot information. The on-shoot information is a piece of information that relates to a shooting scene at the time of shooting; whereas the image processing control information is a piece of information that designates an image processing condition for the image data. In such a case, the use of at least one of the on-shoot information that is responsive to the shooting scene and the image processing control information that designates the image processing condition for the image data allows for more appropriate determination of the shooting scene.

The image processing method of the second aspect of the present invention may further comprise acquiring an image quality correction condition that corresponds to the determined shooting scene; and executing an image quality adjustment of the image data by applying the acquired image quality correction condition. This allows for execution of appropriate image quality adjustment in a way responsive to the shooting scene that is determined by the analysis on the image data.

In place of the step of determining a shooting scene, the image processing method of the second aspect of the present invention may further comprise the step of selecting a shooting scene that corresponds to the decided characteristic hue from among a plurality of previously provided shooting scenes. In such a case, provision of the typical shooting scenes allows for quick selection of the shooting scene.

A third aspect of the present invention provides an image processing method. The image processing method of the third aspect of the present invention comprises acquiring image data that is comprised of plural pieces of pixel data; acquiring hue information and texture information of the acquired image data by analyzing the image data on a pixel-by-pixel basis; deciding a characteristic hue that characterizes the image data by using the acquired hue information; specifying pixel data having the decided characteristic hue from among the acquired image data; deciding a texture of an area that is formed of the specified pixel data by using the acquired texture information; deciding an image quality correction condition for the image data according to the decided characteristic hue and texture; and executing an image quality adjustment of the image data by applying the decided image quality correction condition.

According to the image processing method of the third aspect of the present invention, hue information and texture information of the image data is acquired by the analysis of the image data, a characteristic hue that characterizes the image data is decided by the use of the acquired hue information, a texture of an area that is formed of the specified pixel data is decided through the use of the acquired texture information, an image quality correction condition for the image data is decided according to the decided characteristic hue and the extracted texture, and an image quality adjustment of the image data is executed by applying the decided image quality correction condition. In other words, the analysis of the image data allows the image quality correction condition for the image data to be decided so as to meet the characteristic of the image data. This allows for execution of appropriate image quality adjustment of the image data.

In the image processing method of the third aspect of the present invention, an image quality correction condition may be decided by: determining a shooting scene through the use of the decided characteristic hue and texture; and then by acquiring an image quality correction condition that corresponds to the determined shooting scene, and an image quality adjustment of the image data may be executed by applying the acquired image quality correction condition to the image data. In such a case, the analysis of the image data allows the shooting scene to be determined and thus the image quality correction condition for the image data to be decided so as to meet the decided shooting scene. This allows for execution of appropriate image quality adjustment of the image data.

In the image processing method of the third aspect of the present invention, an image quality correction condition may be decided by: selecting a shooting scene that corresponds to the decided characteristic hue and texture from among a plurality of previously provided shooting scenes; and then by acquiring an image quality correction condition that corresponds to the selected shooting scene, and an image quality adjustment of the image data may be executed by applying the acquired image quality correction condition to the image data. In such a case, the preparation of typical shooting scenes allows for quick selection of a shooting scene, and since any shooting scene to be selected has a predictable width, an image quality correction condition can be setup appropriately according to the predicted shooting scene.

A forth aspect of the present invention provides an image processing device. The image processing device of the fourth aspect of the present invention comprises: an image data acquisition module that acquires image data; a decision module that decides a characteristic hue that characterizes the acquired image data by analyzing the image data; and an image quality adjustment module that executes an image quality adjustment of the image data according to the decided characteristic hue.

The image processing device of the fourth aspect of the present invention has the same functions and effects as the image processing method of the first aspect of the present invention. In addition, the image processing device of the fourth aspect of the present invention may be actualized in various aspects in a similar way as the image processing method of the first aspect of the present invention.

A fifth aspect of the present invention provides an image processing device. The image processing device of the fifth aspect of the present invention comprises: an image data acquisition module that acquires image data; a decision module that decides a characteristic hue that characterizes the acquired image data by analyzing the image data on a pixel-by-pixel basis; and a shooting scene determination module that determines a shooting scene by using the decided characteristic hue.

The image processing device of the fifth aspect of the present invention has the same functions and effects as the image processing method of the second aspect of the present invention. In addition, the image processing device of the fifth aspect of the present invention may be actualized in various aspects in a similar way as the image processing method of the second aspect of the present invention.

A sixth aspect of the present invention provides an image processing device. The image processing device of the sixth aspect of the present invention comprises: an image data acquisition module that acquires image data that is comprised of plural pieces of pixel data; an acquisition module that acquires hue information and texture information of the acquired image data by analyzing the image data on a pixel-by-pixel basis; a characteristic hue decision module that decides a characteristic hue that characterizes the image data, by using the acquired hue information; a specification module that specifies pixel data having the decided characteristic hue from among the acquired image data; a texture decision module that decides a texture of an area that is formed of the specified pixel data, by using the texture information; an image quality correction decision module that decides an image quality correction condition for the image data according to the decided characteristic hue and the extracted texture; and an image quality adjustment module that executes an image quality adjustment of the image data by applying the decided image quality correction condition.

The image processing device of the sixth aspect of the present invention has the same functions and effects as the image processing method of the third aspect of the present invention. In addition, the image processing device of the sixth aspect of the present invention may be actualized in various aspects in a similar way as the image processing method of the third aspect of the present invention.

In addition, the image processing methods of the first through third aspects of the present invention may also be actualized as recording media that have image processing programs respectively recorded therein.

### BRIEF DESCRIPTION OF THE DRAWINGS

FIG. 1 is a schematic diagram that shows an example of an image processing system that includes a personal computer as an image processing device of the present embodiment;

FIG. 2 is a block diagram that shows functions to be executed by the CPU 30 of the personal computer PC of the present embodiment;

FIG. 3 is a flowchart that shows a processing routine of the image processing to be executed by the personal computer PC of the present embodiment;

FIG. 4 is a schematic diagram that conceptually shows an example of reduced image data buffer of image data that is mainly composed of sky;

FIG. 5 is a schematic diagram that shows an example of a graph to be obtained as a result of two-dimensional Fourier transformation of the reduced image data buffer shown in FIG. 4;

FIG. 6 is a schematic diagram that conceptually shows an example of reduced image data buffer of image data that is mainly composed of sea;

FIG. 7 is a schematic diagram that shows an example of a graph to be obtained as a result of two-dimensional Fourier transformation of the reduced image data buffer shown in FIG. 6;

FIG. 8 is a schematic diagram that shows an example of a map used for determination of a shooting scene, which is executed with use of a characteristic hue and a texture of an area of the characteristic hue with respect to the image data; and

FIG. 9 is a schematic diagram that shows an example of a map that describes details of correction by each image quality parameter for each type of the decided shooting scene.

### DETAILED DESCRIPTION OF THE PREFERRED EMBODIMENTS

The following describes an image processing device and an image processing method of the present invention on the basis of examples and with reference to the drawings.

A. Arrangement of Image Processing System

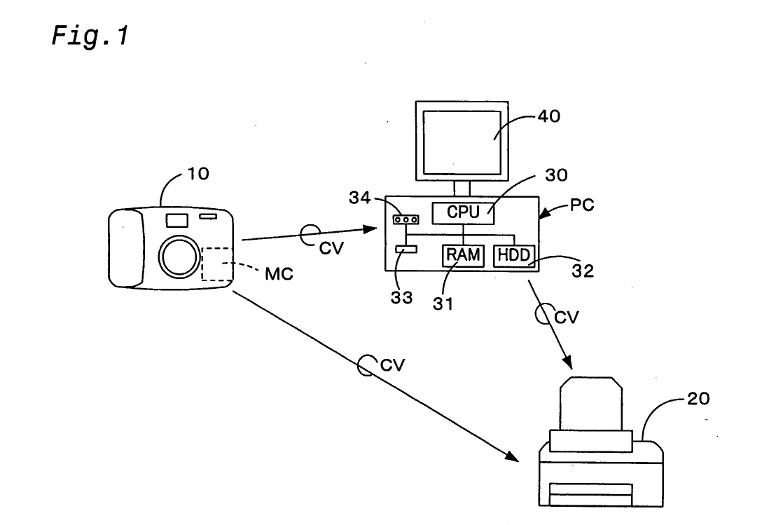

An arrangement of an image processing system, to which an image processing device of the present embodiment can be applied, will now be described with reference to FIG. 1. FIG. 1 is a schematic diagram that shows an example of an image processing system that includes a personal computer as an image processing device of the present embodiment.

The image processing system includes: a digital still camera 10 as an input device that generates image data; a personal computer PC as an image processing device that determines a shooting scene of an image by analyzing the image data generated by the digital still camera 10 as well as executes image processing that is appropriate for the determined scene to output image data for printing; and a color printer 20 as an output device that outputs an image by using the image data for printing. The color printer 20 may also have the function of image processing, which is of the personal computer PC. In such a case, the color printer 20 can execute both the image processing and the image output in a stand-alone mode. As the output device, other devices such as a monitor 40 (e.g. CRT display or LCD display) and a projector may also be used as well in place of the color printer 20. In the following description, however, the color printer 20 in connection with the personal computer PC is used as the output device.

The personal computer PC is a generally used type of computer and includes: a CPU 30 that executes programs for image processing including shooting scene determination processing that is executed through the analysis of image data: a RAM 31 that temporally stores data such as results of operation by the CPU 30 and the image data; and a hard disc drive (HDD) 32 that stores the programs for image processing. The personal computer PC also includes: a card slot 33 for receiving a memory card MC; and an input/output terminal 34 for receiving a connecting cable from e.g. the digital still camera 10.

The digital still camera 10 is a camera that acquires digital images by imaging optical information onto a photoelectric transducer element (CCD or photomultiplier) and includes: a photoelectric transducer circuit that has a CCD or the like for transducing the optical information into electrical information; an image acquisition circuit for acquiring an image by controlling the photoelectric transducer circuit; and an image processing circuit for processing the acquired digital image. The digital still camera 10 saves the acquired image as digital data into the memory card MC as a storage device. Although the digital still camera 10 generally employs JPEG data format as a lossy compression saving mode and TIFF data format as a lossless compression saving mode, other saving modes may also be used as well, including RAW data format, GIF data format, BMP data format, and the like.

The image data generated in the digital still camera 10 is transmitted to the color printer 20 via a cable CV and the computer 20 or directly via a cable CV, for example. Alternatively, the mage data may be transmitted to the color printer 20 via the memory card MC, in which the image data is stored by the digital still camera 10, which is received in the card slot 33 of the computer PC or is directly connected to the printer 20. The following describes a case in which the personal computer PC executes image processing of the image data and then outputs the processed image data to the color printer 20 along with a print control command.

The color printer 20 is a printer that is capable of outputting color images. For example, the color printer 20 is an inkjet printer that forms images by spouting four colors of inks, i.e. cyan (C), magenta (M), yellow (Y), and black (K) onto printing media to form dot patterns. The color printer 20 may alternatively be an electro-photographic printer that forms images by transferring and fixing color toners onto printing media. As for the color inks, light cyan (LC), light magenta (LM), and dark yellow (DY) may also be used as well in addition to the afore-mentioned four colors.

B. Image Processing in Personal Computer PC:

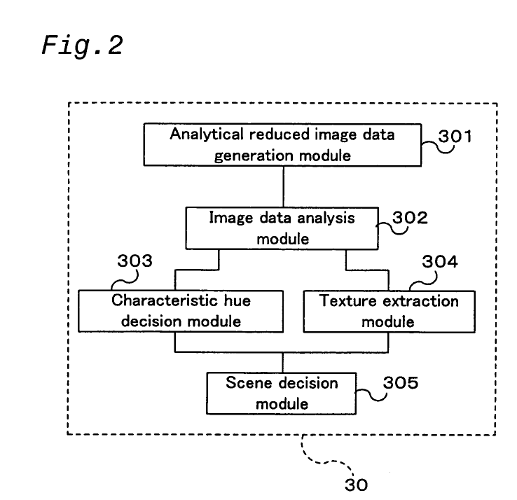

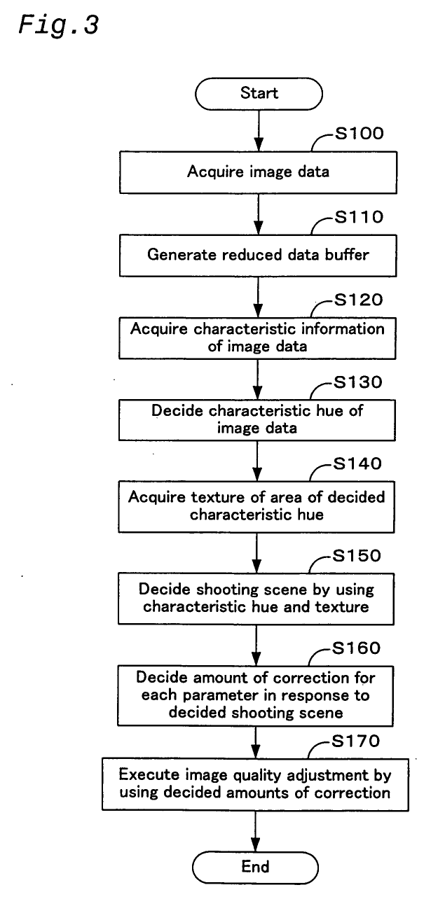

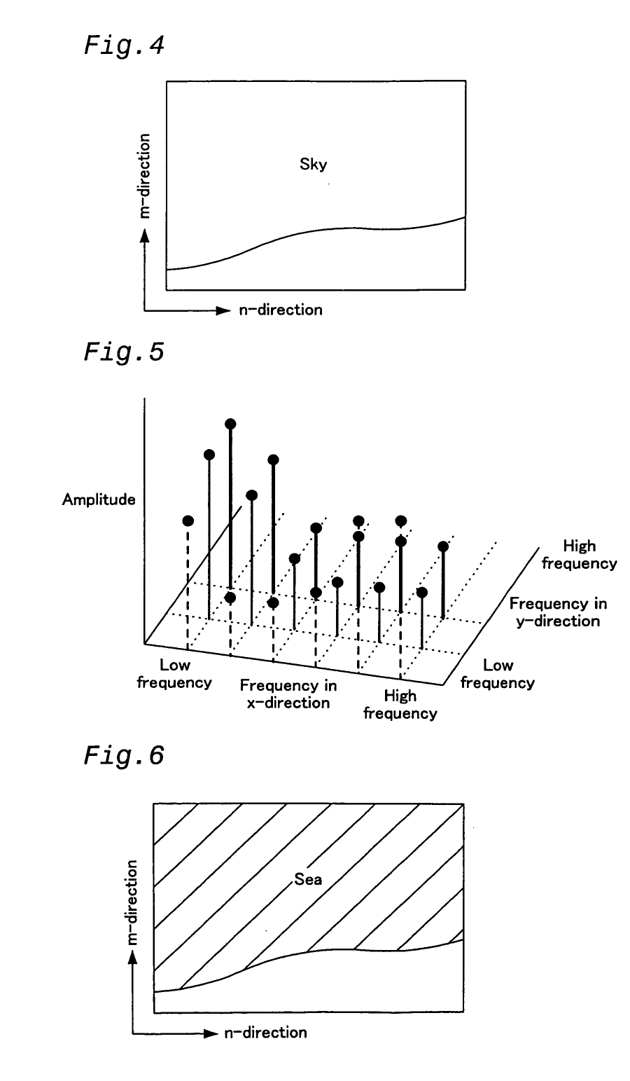

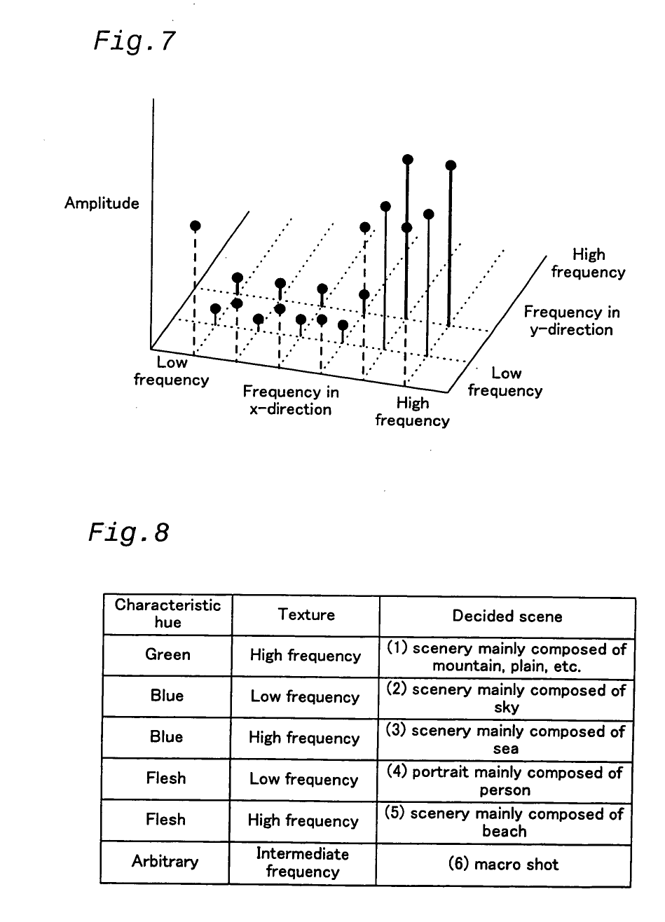

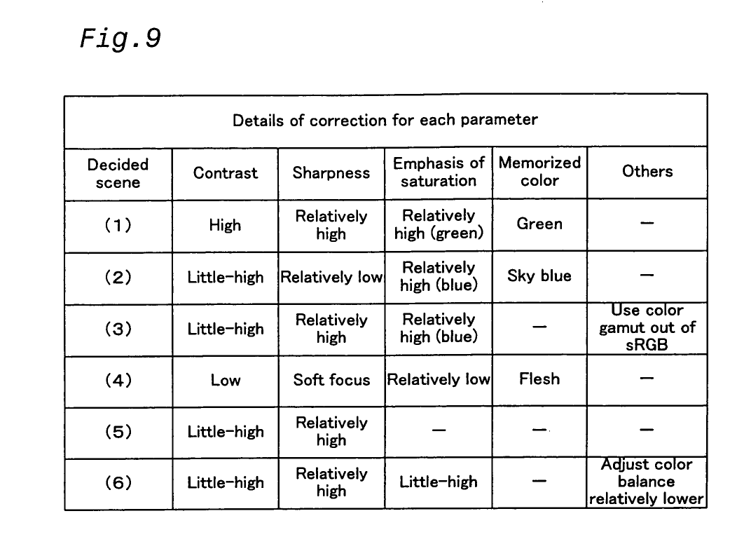

The following describes the image processing to be executed in the personal computer 20 with reference to FIGS. 2 to 9. FIG. 2 is a block diagram that shows functions to be executed by the CPU 30 of the personal computer PC of the present embodiment. FIG. 3 is a flowchart that shows a processing routine of the image processing to be executed by the personal computer PC of the present embodiment. FIG. 4 is a schematic diagram that conceptually shows an example of reduced image data buffer of image data that is mainly composed of sky. FIG. 5 is a schematic diagram that shows an example of a graph to be obtained as a result of two-dimensional Fourier transformation on the reduced image data buffer shown in FIG. 4. FIG. 6 is a schematic diagram that conceptually shows an example of reduced image data buffer of image data that is mainly composed of sea. FIG. 7 is a schematic diagram that shows an example of a graph to be obtained as a result of two-dimensional Fourier transformation on the reduced image data buffer shown in FIG. 6. FIG. 8 is a schematic diagram that shows an example of map that is used for determination of a shooting scene, which is executed through the use of a characteristic hue of image data and a texture of an area of the characteristic hue. FIG. 9 is a schematic diagram that shows an example of a map that describes for each type of the decided shooting scene the details of correction to be executed by each image quality parameter.

Functions to be achieved by the CPU 30 are now described with reference to FIG. 2. An analytical reduced image data generation module 301 of the CPU 30 generates reduced image data for analytical use based on input image data. An image data analysis module 302 analyzes the generated analytical reduced image data on a pixel-by-pixel basis and acquires R, G, B components of each pixel that constitutes the analytical reduced image data (image data). A characteristic hue decision module 303 of the CPU 30 uses the result of analysis on the analytical reduced image data to decide a characteristic hue, which is a hue that characterizes the image data. A texture extraction module 304 of the CPU 30 decides a pixel area that corresponds to the characteristic hue decided by the characteristic hue decision module 303, executes a frequency analysis of the analytical reduced image data through the use of a two-dimensional Fourier transmission or the like, and extracts a texture of the pixel area that corresponds to the characteristic hue. A scene decision module 305 of the CPU 30 decides a shooting scene of the shooting image (image data) based on the obtained characteristic hue and the texture of the pixel area that represents the characteristic hue.

Shooting scene determination processing to be executed by the personal computer PC and image quality adjustment processing based on a determined shooting scene are now described with reference to FIG. 3. When a memory card MC is inserted in the slot 33 or when a connecting cable CV that connects to the digital still camera 10 is connected to the input/output terminal 34, the personal computer PC (CPU 30) activates programs for the determination processing and the image processing. The CPU 30 acquires (reads out) image data, which is selected by a user, from the memory card MC and temporarily stores the acquired image data into the RAM 31 in step S100.

The CPU 30 (analytical reduced image data generation module 301) generates reduced image data buffer for the analysis of image data from the acquired image data in step S110. Then CPU 30 (image data analysis module 302) scans the generated reduced image data buffer in n-direction (transverse direction in FIG. 4 and FIG. 6) and acquires hue information of the image data in step S120. Specifically, the CPU 30 acquires R, G, B values of each pixel in relation to its corresponding coordinate location (n, m).

The CPU 30 (characteristic hue decision module 303) uses the acquired hue information to decide a characteristic hue of the image data that characterizes the shooting image in step S130. Specifically, the CPU 30 executes processing that, for every pixel that constitutes the reduced image data buffer, counts and relates an observed pixel to a hue if the observed pixel and its adjacent pixel (in the n-direction) have the identical hue and does not count an observed pixel if the observed pixel and its adjacent pixel (in the n-direction) do not have the identical hue. In the present embodiment, such determination is executed for every hue of blue, green, flesh, and red, and the identity of hue is determined not based on the exact identity of R, G, B values but based on whether or not R, G, B values are included within a predefined range.

The CPU 30 founds for each hue a proportion of the number of pixels that are counted for the hue to the total number of pixels that constitute the reduced image data buffer, and uses a previously provided map to decide a characteristic hue of the image data. The map describes the characteristic hue corresponding with a ratio of the numbers of pixels for each hue in the image data.

The examples shown in FIG. 4 and FIG. 6 correspond to scenic image data that is mainly composed of sky and scenic image data that is mainly composed of sea, respectively, and have characteristic hues of blue. It is not apparent, however, that the hue of blue indicates either the blue of sky or the blue of sea.

In order to deal with the problem, the CPU 30 (texture extraction module 304) acquires a texture of an area that has the decided characteristic hue in step S140. Specifically, the CPU 30 specifies a pixel area that represents the characteristic hue and executes a frequency analysis on the specified pixel area. The pixel area that represents the characteristic hue is specified based on information on the hue and coordinate location of each pixel, which is included in the hue information. The frequency analysis of the specified pixel area is executed in the n-direction and m-direction of the analytical reduced image data buffer through the use of a two-dimensional Fourier transformation that is indicated by the following equation 1.

$${G}_{XY} = {\sum }_{n = 0}^{N - 1} {\sum }_{m = 0}^{M - 1} g ( n , m ) exp ( - j 2 π nX / N ) ⋆ exp ( - j2 π mY / M ) \qquad Equation 1$$

In Equation 1, the value g (n, m) indicates the location of each pixel in the analytical reduced image data buffer and values N, M indicate the numbers of pixels included in the n-direction and the m-direction of the analytical reduced image data buffer, respectively. The values X, Y represent the frequency area (spatial axes) after the transformation. The value G_{XY}, which is to be obtained from the equation 1, is the frequency of a pixel at the coordinate point of g(n, m) in the analytical reduced image data buffer, which is a location that corresponds to the coordinate point of (X, Y) after the transformation.

The relationship between the results of two-dimensional Fourier transformation and the textures is now described with reference to FIGS. 4 to 7. As described previously, the analytical reduced image data buffer shown in FIG. 4 corresponds to an image of scenery that is mainly composed of sky and has a characteristic hue of blue. The graph shown in FIG. 5 may be obtained as a result of two-dimensional Fourier transformation on the analytical reduce image data buffer. An image of sky generally has a smooth surface with fewer patterns and thus tends to represent a larger numbers of low frequency components and a smaller number of high frequency components.

On the other hand, the analytical reduced image data buffer shown in FIG. 6 corresponds to an image of scenery that is mainly composed of sea and has a characteristic hue of blue, as described previously. The graph shown in FIG. 7 may be obtained as a result of two-dimensional Fourier transformation on the analytical reduced image data buffer. An image of sea generally has more patterns due to ripples and thus tends to represent a smaller number of low frequency components and a larger number of high frequency components.

Considering such tendencies, it turns out that even if two or more images have one identical characteristic hue, the feature (subject) of each image can be further specified through the determination of texture of each area that makes up the characteristic hue. This allows for high precision specification of a shooting scene.

The CPU 30 (scene decision module 305) decides a shooting scene by using the acquired characteristic hue and the texture of the pixel area that corresponds to the characteristic hue in step S150. The map shown in FIG. 8, for example, is used for the determination of shooting scene.

(1) If the characteristic hue is green and the extracted texture has a high frequency, the image is decided (determined) to be a scenic shooting scene that is mainly composed of green such as mountain and plain.

(2) If the characteristic hue is blue and the extracted texture has a low frequency, the image is decided to be a scenic shooting scene that is mainly composed of sky.

(3) If the characteristic hue is blue and the extracted texture has a high frequency, the image is decided to be a scenic shooting scene that is mainly composed of sea.

(4) If the characteristic hue is flesh and the extracted texture has a low frequency, the image is decided to be a portrait shooting scene that is mainly composed of person.

(5) If the characteristic hue is flesh and the extracted texture has a high frequency, the image is decided to be a scenic shooting scene of beach or the like.

(6) If a specific hue occupies the major part of the image as the characteristic hue and the extracted texture has a frequency not so high, the image is decided to be a macro shooting scene. In addition, if there are many areas with high saturations or if there is any area with a hue of green, the image is determined to be a macro shooting scene of flowers.

The CPU 30 decides an amount of correction for each parameter in response to the decided shooting scene in step S160. Specifically, the CPU 30 refers to the map shown in FIG. 9, and for each image quality parameter, acquires details of correction that is appropriate for the determined (decided) shooting scene and thereby decides an amount of correction. In the present embodiment, each image quality parameter such as contrast, sharpness, and saturation (emphasis) has varying amount of correction depending on the type of shooting scene.

As for a shooting scene of the type (5), since it is highly possible that sea is shot as well, there may be additional details of correction such as “Emphasis of Saturation=Relatively-High” and “Use Out of Color Gamut of sRGB.” If a shooting scene of the type (6) is determined to be of flowers, there may be alternative details of correction such as “Contrast=Little-Low,” “Sharpness=Ordinary,” “Emphasis of Saturation=Little-High,” and “Color to Memorize=Green.”

The CPU 30 executes an image quality adjustment of the image data by using the decided amounts of correction and ends the present processing routine in step S170. The CPU 30 may complete the image quality adjustment of the image data by applying the decided amounts of correction (details of correction) directly to the image data. Alternatively, the CPU 30 may analyze the image data, acquire the value (statistic) of each image quality parameter that characterizes the image data, and then adjust the image quality of the image data so as to eliminate or reduce the deviation between the actual value and a previously provided target value (reference value) of each image quality parameter. In other words, the details of correction decided in the present embodiment are used to eliminate or reduce the deviation between the actual value and the previously provided target value of each image quality parameter. In such a case, the CPU 30 may execute another analysis on the image data to acquire the value of each image quality parameter, or may acquire the value of each image quality parameter during the previous analysis for acquiring the hue information and use the acquired value into the analysis of this time. The CPU 30 executes the correction of the image data by, for example: applying the amount of correction to a tone curve, which defines the relationship of output values to input values, to modify each acquired amount of correction; and use the tone curve to modify R, G, and B values of each pixel that is included in the image data.

The image data that has undergone the image quality adjustment is output to a printer driver. The printer driver executes color conversion processing that converts the image data (RGB data) into CMYK data. That is to say, the printer driver converts the color system of the image data into a CMYK color system, i.e. a color system that is used by the color printer 20 to execute print processing. Specifically, the color conversion processing is executed through the use of a look up table that is stored in the HDD 32 and defines the relationship between the RGB color system and the CMYK color system. The image data also undergoes halftone processing and resolution conversion processing, and is output to the color printer 20 in the form of raster data that includes a control command for printing.

As described above, the personal computer PC as an image processing device of the present embodiment determines a shooting scene by using a characteristic hue that is obtained by the analysis of image data and a texture of an area that represents the characteristic hue. This allows for high precision determination of a shooting scene based on the analysis of the image data.

In other words, since each shooting scene has a hue that characterizes the scene, a shooting scene of image data can be specified through a comparison between a characteristic hue that characterizes the image data and each hue that characterizes each type of shooting scene. In addition, a texture is extracted through a frequency analysis of constituent pixels of an area that represents the characteristic hue of the image data. This allows for proper decision of a shooting scene of image data, even if a plurality of shooting scenes has one identical hue as their respective characteristic hues.

Consequently, even if the image data is not attached with information that relates to the shooting scene, the shooting scene can be specified only on the basis of the image data and an image quality adjustment of the image data can be executed according to the shooting scene without bothering a user.

C. Other Embodiments:

Although the shooting scene is determined through the use of the characteristic hue of the image data and the texture of the area of the characteristic hue in the above described embodiment, the shooting scene may alternatively be determined through the use of other information such as image processing control information that designates a condition for image processing or on-shoot information that describes a condition for shooting. The image processing control information can designate values of respective image quality parameters according to a shooting scene that was designated by the digital still camera 10; whereas the on-shot information can describe a shooting scene that was set up by the digital still camera 10. Accordingly, the use of either the designated values of the respective image quality parameters or the shooting scene that was set up by the digital still camera 10 along with the shooting scene that was obtained by the analysis on the image data allows for proper decision of the shooting image and thus execution of the image quality adjustment appropriate for the shooting scene.

Although the analytical reduced image data buffer is used to obtain the hue and frequency of the image data in the above-described embodiment, original image data (non-reduced image data) may alternatively be used as well. This allows for execution of more accurate analysis.

Although the characteristic hue and the texture are used to specify the shooting scene in the above-described embodiment, the characteristic hue may alternatively be used alone or along with the on-shoot information and the image processing control information to decide the shooting scene.

In the determination of shooting scene for a portrait image that is mainly composed of person(s) in the above-described embodiment, additional judgments may also be executed as well, such as a pattern matching for edges of the entire parts of faces, a pattern matching for each part of faces, and a learned neural network. This allows for execution of more accurate determination of whether or not the image data or the target of the processing corresponds to a shooting image that is mainly composed of person(s). In addition, since an area of face can be extracted from the area of portrait, in case where the area of face is dark, the image can be judged as a backlit scene and thus can undergo an additional correction (gamma correction) that makes the dark area brighter than the normal brightness correction does.

Although the two-dimensional Fourier transformation is used for the extraction of texture, other transformation such as a wavelet transformation may alternatively be used as well, as long as the frequency analysis of the image data (the extraction of the texture) can be attained.

Although the characteristic hue of the image data is determined and the texture is extracted (the frequency analysis is executed) with respect to the area that is represented by the characteristic hue (constituent pixels that constitute such area) in the above-described embodiment, the texture may alternatively be extracted with respect to the entire image data. In such a case, the result of the texture extraction and its regional (positional) information on the image data may be associated with one another and may be compared with regional information of the characteristic hue. This allows for acquisition of the texture with respect to the area that represents the characteristic hue.

Although the characteristic hue and the texture are used as parameters to select the shooting scene from the previously provided shooting scene candidates in the above-described embodiment, the characteristic hue and the texture may alternatively be used to decide the amounts of correction for the respective image quality parameters, whenever it is necessary.

Although the term “shooting scene” is used in the execution of the image quality adjustment in the above-described embodiment, the term “shooting scene” may not necessarily be used, but a group of predefined image quality adjustment parameters may alternatively be specified and the values of the respective image quality adjustment parameters may be decided through the use of the characteristic hue and the texture.

Although the personal computer PC is used as an image processing device to execute the image processing in the above-described embodiment, other devices may alternatively be used as well. Examples of such alternative devices include a stand-alone type printer with the function of image processing and a digital still camera. In such a case, the printer or the digital still camera executes the image processing. Alternatively, the image processing may be implemented as a printer driver or an image processing application (program) with no accompanying hardware configuration such as the image processing device.

Although the image processing device and the image processing method of the present invention have been described above in terms of embodiments, these embodiments are only purposed to facilitate understanding of the present invention and are not considered to limit the present invention. There may be various changes, modifications, and equivalents without departing from the scope and spirit of the claims of the present invention.

1-14. (canceled)

15. A digital still camera comprising:
a shooting module that shoots an image;
a shooting condition receiver that receives a shooting condition;
an extracting module that extracts a facial image area from the image; and
an image processing module that implements image processing on the image based on the received shooting condition and a property of the extracted facial image area.

16. A digital still camera according to claim 15, wherein the image processing includes correction of brightness of the image, contrast of the image, sharpness of the image or saturation of the image.

17. A digital still camera according to claim 16, wherein the correction of brightness is implemented when brightness of the facial image area is lower than remaining image areas.

18. A digital still camera according to claim 17, wherein an amount of the correction of contrast when the facial image area is extracted is smaller than when the facial image area is not extracted.

19. A digital still camera according to claim 18, wherein the facial image area is extracted by way of pattern matching.

20. An image processing apparatus comprising:
an extracting module that extracts a facial image area from an image; and
an image correcting module that corrects the image based on an image generating condition and a property of the extracted facial image area.

21. A computer program product comprising:
a computer readable medium; and
a computer program stored on the computer readable medium, the computer program including
program code for extracting a facial image area from an image; and
program code for correcting the image based on an image generating condition and a property of the extracted facial image area.

22. A method of image processing comprising:
extracting a facial image area from an image; and
correcting the image based on an image generating condition and a property of the extracted facial image area.
